(19) United States
(12) Patent Application Publication
(10) Pub. No.: US 2023/0251648 A1
(43) Pub. Date: Aug. 10, 2023

(54) INTELLIGENT VEHICLE SYSTEMS AND CONTROL LOGIC FOR IN-VEHICLE ASSET NOTIFICATION AND MANAGEMENT

(71) Applicant: GM GLOBAL TECHNOLOGY OPERATIONS LLC, Detroit, MI (US)

(72) Inventors: Michael A. Gutierrez, Dearborn Heights, MI (US); Russell A. Patenaude, Macomb Township, MI (US)

(73) Assignee: GM GLOBAL TECHNOLOGY OPERATIONS LLC, Detroit, MI (US)

(21) Appl. No.: 17/668,523

(22) Filed: Feb. 10, 2022

(51) Int. Cl. G05D 1/00; H04W 4/48; H04W 4/44; B60R 25/01; B60Q 9/00; B60H 1/00

(52) U.S. Cl. CPC G05D 1/0022; H04W 4/48; H04W 4/44; B60R 25/01; B60Q 9/00; B60H 1/00657

(57) ABSTRACT

Presented are intelligent control systems for flexible notification and management of in-vehicle assets, methods for making/using such systems, and vehicles equipped with such systems. A method of operating a motor vehicle includes a vehicle controller detecting, via a resident communications interface (RCI) device, an electronic asset within a compartment of the motor vehicle. Responsive to detecting the asset, the controller accesses a memory device to retrieve device data specific to the asset. This device data contains a set of conditional criteria predetermined to protect the asset while in the vehicle compartment. The controller also detects when the vehicle is stopped; upon detecting the vehicle has stopped, the controller determines if any one of the conditional criteria has been met. If so, the controller responsively commands one or more resident vehicle subsystems of the vehicle to execute one or more automated control operations to protect the asset while inside the vehicle.

### INTRODUCTION

The present disclosure relates generally to motor vehicles. More specifically, aspects of this disclosure relate to intelligent control systems provisioning flexible asset notification and management for in-vehicle electronic devices of motor vehicles.

Current production motor vehicles, such as the modern-day automobile, may be equipped with a resident network of electronic control units, connection buses, and communications devices that enable the vehicle to interface with permanent and portable electronic devices (collectively “assets”). Examples of such assets include, but are not limited to, personal assets (e.g., laptop computers, smartphones, tablet computers, smart watches, etc.) and vehicle assets (e.g., navigation units, audio components, flatscreen monitors, etc.). Some in-vehicle assets may be securely mounted to a motor vehicle in order to prevent unauthorized removal of the asset from the vehicle (e.g., when parked). Power lock and security systems may also be employed to prevent unsanctioned ingress to the vehicle and unauthorized removal of in-vehicle assets. Modern center-stack telematics units allow occupants to pair assets with the vehicle and, if desired, register device-specific information of a paired asset with the vehicle for asset monitoring and control.

### SUMMARY

Presented herein are intelligent vehicle systems with attendant control logic for flexible notification and management of in-vehicle assets, methods for manufacturing and methods for operating such systems, and motor vehicles equipped with such systems. By way of example, there are disclosed flexible asset notification management systems for actively inventorying and monitoring in-vehicle assets. For instance, a wireless interface allows a vehicle occupant to selectively pair an asset, establish a device profile for the asset, and stipulate a set of conditional requirements for managing the asset, such as temperature limits, theft prevention controls, vehicle lock settings, notification triggers, etc. When an asset approaches or enters a vehicle, for example, a short-range communication device of the asset automatically connects to a wireless interface device within the vehicle cabin. The vehicle responsively retrieves device-specific data and settings for the paired asset; if none is available, the asset user is prompted to enter such device information. The vehicle actively monitors the asset so long as the short-range device remains in proximity to and connected with the vehicle's wireless interface. If one of the predefined conditional criteria is met during asset monitoring, the vehicle automatically notifies the user (e.g., telematics unit or digital instrument cluster displays a user prompt) and takes protective action (e.g., locks the vehicle, changes the cabin temperature, contacts a remote vehicle service, etc.).

Aspects of this disclosure are directed to intelligent control systems, system control logic, and closed-loop feedback control techniques for flexible notification and management of in-vehicle assets. In an example, a method is presented for operating a motor vehicle, including hybrid-electric vehicles (HEV), full-electric vehicles (FEV), and internal combustion engine (ICE) variants. This representative method includes, in any order and in any combination with any of the above and below disclosed options and features: detecting, e.g., via a resident or remote vehicle controller in cooperation with a resident communications interface (RCI) device inside the vehicle, an electronic asset within a compartment of the motor vehicle; retrieving, e.g., via the controller from a resident or remote memory device responsive to detecting the asset, device data specific to the detected asset, the device data containing device-specific identification information and conditional criteria designed to protect the asset while inside the vehicle compartment; detecting, e.g., via the controller in cooperation with a powertrain control module (PCM), a vehicle starter system, or a gear shift device (PRNDL), the motor vehicle is stopped; determining, e.g., via the vehicle controller responsive to detecting that the vehicle is stopped, if one or more conditional criteria in the set of conditional criteria has been met; and transmitting, e.g., via the vehicle controller to one or more resident vehicle subsystems of the motor vehicle, one or more command signals to execute one or more automated control operations responsive to determining a conditional criterion has been met.

Additional aspects of this disclosure are directed to intelligent motor vehicles equipped with flexible asset notification and management systems. As used herein, the terms “vehicle” and “motor vehicle” may be used interchangeably and synonymously to include any relevant vehicle platform, such as passenger vehicles (ICE, REV, FEV, fuel cell, fully and partially autonomous, etc.), commercial vehicles, industrial vehicles, tracked vehicles, off-road and all-terrain vehicles (ATV), motorcycles, farm equipment, watercraft, aircraft, etc. In an example, a motor vehicle includes a vehicle body with a passenger compartment, multiple drive wheels rotatably mounted to the vehicle body (e.g., via corner modules coupled to a unibody or body-on-frame chassis), and other standard original equipment. A prime mover, such as an electric traction motor (e.g., for HEV and FEV powertrains) and/or an internal combustion engine assembly (e.g., for HEV or ICE powertrains), selectively drives one or more of the road wheels to propel the vehicle. The vehicle is also equipped with a resident communications interface device, such as a BLUETOOTH®, RFID, or dedicated short-range communications (DSRC) transceiver, that is mounted to the vehicle body and operable to communicate with electronic assets.

Continuing with the discussion of the preceding example, the vehicle employs a vehicle controller, such as a microprocessor, control module, control unit, or network of processors/controllers/modules, for detecting and monitoring in-vehicle assets. The controller is programmed to use the RCI device to detect an electronic asset entering or located within one of the vehicle's compartments. Upon detecting the electronic asset, the controller accesses a memory device to retrieve device data that is specific to the detected asset. This device data contains a set of conditional criteria that is designed to protect the asset while in the vehicle compartment. The controller then detects when the motor vehicle is stopping/stopped; upon detecting that the vehicle is stopped, the controller responsively determines if any one or more of the criteria in the set of conditional criteria has been met. If so, the controller automatically commands one or more vehicle subsystems resident to the motor vehicle to execute at least one automated control operation to protect the asset.

Aspects of this disclosure are also directed to computer-readable media (CRM) for sensing and governing in-vehicle assets. In an example, non-transitory CRM stores instructions executable by one or more processors of a vehicle controller, such as an electronic control unit (ECU) of a center-stack telematics unit. These instructions, when executed by the processor(s), cause the vehicle controller to perform operations, including: detecting an electronic asset within a vehicle compartment using an RCI device; retrieving, from a memory device responsive to detecting the electronic asset, device data specific to the electronic asset, the device data including a set of conditional criteria predetermined to protect the asset while in the vehicle compartment; detecting the motor vehicle is stopped; determining, responsive to detecting the motor vehicle is stopped, if a conditional criterion in the set of conditional criteria has been met; and transmitting, to a resident vehicle subsystem of the motor vehicle, a command signal to execute an automated control operation responsive to determining the conditional criterion has been met.

For any of the disclosed vehicles, systems, and methods, the electronic asset is equipped with a short-range communications (SRC) device. In this instance, detecting an asset within a vehicle compartment may include the vehicle's RCI device wirelessly pairing with the asset's SRC device. As yet a further option, asset-specific device data may be retrieved by: determining device data for a detected asset does not currently exist in the memory device; prompting a user of the motor vehicle to enter the device data; and storing the entered device data, associated with a unique identifier of the electronic asset, in the memory device. Furthermore, the conditional criteria may include one or more notification criteria, such as a notification type setting (e.g., text, call, push, telematics prompt, etc.) and/or a notification transmission time setting (e.g., immediate notification, X-minute delay, snooze period, etc.). In the same vein, the conditional criteria may include one or more temperature criteria, such as a temperature threshold setting (e.g., maximum and/or minimum cabin temperature) and/or a temperature notification setting (e.g., immediate notification, X-minute delay, snooze period, etc.). The conditional criteria may also include one or more lock system criteria, such as a lock status setting (e.g., vehicle unattended, unlocked and stopped) and/or a lock notification setting (e.g., immediate notification, X-minute delay, snooze period, etc.).

For any of the disclosed vehicles, systems, and methods, the resident vehicle subsystem may include an electronic display device that is mounted inside the vehicle's passenger compartment. In this instance, the command signal causes the display device to display a notification to vehicle occupants indicating that a conditional criterion of the asset has been met. After displaying the notification, the vehicle controller may receive a snooze input from a user (e.g., via a resident HMI) to snooze the notification. After receiving the snooze input, the controller responsively determines if a memory-stored or user-selected notification timer has expired; if so, the in-vehicle display device responsively displays another (second) notification that indicates the conditional criterion has been met. Any of the herein described notifications may be provisioned by a permanent in-vehicle device or sent directly to a user, e.g., via a laptop computer, smartphone, smart watch, etc.

For any of the disclosed vehicles, systems, and methods, the resident vehicle subsystem may include a power lock system that is operable to lock and thereby secure closed the passenger compartment. In this instance, the command signal causes the power lock system to enter a lock mode and, thus, lock the passenger compartment responsive to a conditional criterion being met. Before entering the lock mode, the vehicle controller may transmit a visual/audible prompt to a user of the motor vehicle to approve locking of the vehicle. After receiving the user's approval to lock the motor vehicle, the vehicle controller responsively commands to power lock system to enter the lock mode.

For any of the disclosed vehicles, systems, and methods, the resident vehicle subsystem may include a telecommunications and informatics (telematics) unit that is mounted inside the vehicle's passenger compartment. In this instance, the command signal causes the telematics unit to transmit an intervention service request to a third-party vehicle service (e.g., ONSTAR®) that is remote from the motor vehicle. For example, after detecting an asset within the vehicle compartment, the controller utilizes the RCI device to detect removal of the asset from the vehicle compartment. If the asset is removed while the vehicle is stopped and the compartment is locked, the controller may conclude that the removal was illicit and therefore command the telematics unit to transmit a service request to the remote vehicle service provider to intervene (e.g., contact the authorities, activate a vehicle alarm, contact the vehicle owner, etc.

For any of the disclosed vehicles, systems, and methods, the resident vehicle subsystem may include an in-vehicle heating, ventilation and air-conditioning (HVAC) system that is operable to regulate a cabin temperature of the passenger compartment. In this instance, the command signal activates the HVAC system to heat or cool the passenger compartment to a predefined cabin temperature that is retrieved from the conditional criteria specific to the detected asset. Prior to HVAC activation, the vehicle controller may transmit a visual/audible prompt to a user of the motor vehicle to approve activation of the HVAC system. Upon receiving user approval for HVAC activation, the controller commands the HVAC system to sufficiently heat/cool the passenger compartment, e.g., to raise/lower the cabin temperature to within a user-defined operating temperature range. Optional conditional criteria may include a designation as perishable, a designation as valuable, a device charge status, a designation to not leave during day/night, etc.

The above Summary is not intended to represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle with a resident network of controllers, sensing devices, and communication devices for in-vehicle asset management according to aspects of the disclosed concepts.

FIG. 2 is a flowchart illustrating a representative asset detection and settings retrieval algorithm for flexible notification and management of in-vehicle assets, which may correspond to memory-stored instructions that are executable by a resident or remote controller, control-logic circuit, programmable control unit, or other integrated circuit (IC) device or network of devices in accord with aspects of the disclosed concepts.

FIG. 3 is a flowchart illustrating a representative automated warning and vehicle response algorithm for flexible notification and management of in-vehicle assets, which may correspond to memory-stored instructions that are executable by a resident or remote controller, control-logic circuit, programmable control unit, or other integrated circuit (IC) device or network of devices in accord with aspects of the disclosed concepts.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Description of the Drawings, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

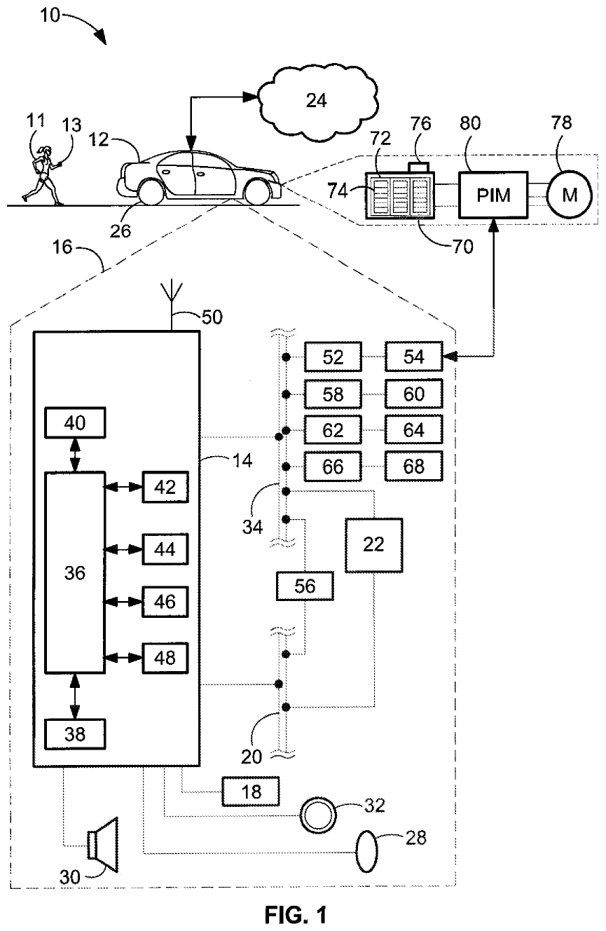

Referring now to the drawings, wherein like reference numbers refer to like features throughout the several views, there is shown in FIG. 1 a representative automobile, which is designated generally at 10 and portrayed herein for purposes of discussion as a sedan-style, electric-drive passenger vehicle. The illustrated automobile 10—also referred to herein as “motor vehicle” or “vehicle” for short—is merely an exemplary application with which novel aspects of this disclosure may be practiced. In the same vein, incorporation of the present concepts into an FEV powertrain should be appreciated as a non-limiting implementation of disclosed features. As such, it will be understood that aspects and features of this disclosure may be applied to other powertrain architectures, incorporated into any logically relevant type of motor vehicle, and utilized for both automotive and non-automotive applications alike. Moreover, only select components of the motor vehicles and asset monitoring systems are shown and described in additional detail herein. Nevertheless, the vehicles and systems discussed below may include numerous additional and alternative features, and other available peripheral components, for carrying out the various methods and functions of this disclosure.

The representative vehicle 10 of FIG. 1 is originally equipped with a vehicle telecommunication and information (“telematics”) unit 14 that wirelessly communicates, e.g., via cell towers, base stations, mobile switching centers, satellite service, etc., with a remotely located or “off-board” cloud computing host service 24 (e.g., ONSTAR®). Some of the other vehicle hardware components 16 shown generally in FIG. 1 include, as non-limiting examples, an electronic video display device 18, a microphone 28, audio speakers 30, and assorted user input controls 32 (e.g., buttons, knobs, pedals, switches, touchpads, joysticks, touchscreens, etc.). These hardware components 16 function, in part, as a human/machine interface (HMI) that enables a user to communicate with the telematics unit 14 and other components resident to and remote from the vehicle 10. Microphone 28 provides a vehicle occupant with means to input verbal or other auditory commands; the vehicle 10 may be equipped with an embedded voice-processing unit utilizing audio filtering, editing, and analysis modules. Conversely, the speakers 30 provide audible output to a vehicle occupant and may be either a stand-alone speaker dedicated for use with the telematics unit 14 or may be part of an audio system 22. The audio system 22 is operatively connected to a network connection interface 34 and an audio bus 20 to receive analog information, rendering it as sound, via one or more speaker components.

Communicatively coupled to the telematics unit 14 is a network connection interface 34, suitable examples of which include twisted pair/fiber optic Ethernet switches, parallel/serial communications buses, local area network (LAN) interfaces, controller area network (CAN) interfaces, and the like. Other appropriate communication interfaces may include those that conform with ISO, SAE, and/or IEEE standards and specifications. The network connection interface 34 enables the vehicle hardware 16 to send and receive signals with one another and with various systems and subsystems both onboard the vehicle body 12 and off-board the vehicle body 12. This allows the vehicle 10 to perform assorted vehicle functions, such as modulating powertrain output, governing operation of the vehicle's transmission, activating the friction and regenerative brake systems, controlling vehicle steering, regulating charge and discharge of the vehicle's battery pack(s), and other automated functions. For instance, telematics unit 14 receives and transmits signals and data to/from a Powertrain Control Module (PCM) 52, an Advanced Driver Assistance System (ADAS) module 54, an Electronic Battery Control Module (EBCM) 56, a Steering Control Module (SCM) 58, a Brake System Control Module (BSCM) 60, and assorted other vehicle ECUs, such as a transmission control module (TCM), engine control module (ECM), Sensor System Interface Module (SSIM), etc.

With continuing reference to FIG. 1, telematics unit 14 is an onboard computing device that provides a mixture of services, both individually and through its communication with other networked devices. This telematics unit 14 is generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to a real-time clock (RTC) 42 and one or more electronic memory devices 38, each of which may take on the form of a CD-ROM, magnetic disk, IC device, flash memory, semiconductor memory (e.g., various types of RAM or ROM), etc.

Long-range vehicle communication capabilities with remote, off-board devices may be provided via one or more or all of a cellular chipset/component, a navigation and location chipset/component (e.g., global positioning system (GPS) transceiver), or a wireless modem, all of which are collectively represented at 44. Close-range wireless connectivity may be provided via a short-range wireless communications device 46 (e.g., a BLUETOOTH® unit, RFID tag/reader, or near field communications (NFC) transceiver), a dedicated short-range communications (DSRC) component 48, and/or a dual antenna 50. It should be understood that the vehicle 10 may be implemented without one or more of the above-listed components or, optionally, may include additional components and functionality as desired for a particular end use. The communications devices described above may provision data exchanges as part of a periodic broadcast in a vehicle-to-vehicle (V2V) communication system or a vehicle-to-everything (V2X) communication system, e.g., Vehicle-to-Infrastructure (V2I), Vehicle-to-Pedestrian (V2P), Vehicle-to-Device (V2D), etc.

CPU 36 receives sensor data from one or more sensing devices that use, for example, photo detection, radar, laser, ultrasonic, optical, infrared, or other suitable technology, including short range communications technologies (e.g., DSRC) or Ultra-Wide Band (UWB) radio technologies, e.g., for executing an automated vehicle operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of in-vehicle sensors may be adapted, singly or collectively, to a given vehicle platform for achieving a desired level of autonomous vehicle operation.

To propel the motor vehicle 10, an electrified powertrain is operable to generate and deliver tractive torque to one or more of the vehicle's drive wheels 26. The powertrain is generally represented in FIG. 1 by a rechargeable energy storage system (RESS), which may be in the nature of a chassis-mounted traction battery pack 70, that is operatively connected to an electric traction motor 78. The traction battery pack 70 is generally composed of one or more battery modules 72 each having a stack of battery cells 74, such as lithium ion, lithium polymer, or nickel metal hydride battery cells of the pouch, can, or prismatic type. One or more electric machines, such as traction motor/generator (M) units 78, draw electrical power from and, optionally, deliver electrical power to the battery pack 70. A power inverter module (PIM) 80 electrically connects the battery pack 70 to the motor/generator unit(s) 78 and modulates the transfer of electrical current therebetween. Disclosed concepts are similarly applicable to HEV and ICE-based powertrains.

The battery pack 70 may be configured such that module management, cell sensing, and module-to-module or module-to-host communication functionality is integrated directly into each battery module 72 and performed wirelessly via a wireless-enabled cell monitoring unit (CMU) 76. The CMU 76 may be a microcontroller-based, printed circuit board (PCB)-mounted sensor array. Each CMU 76 may have a GPS transceiver and RF capabilities and may be packaged on or in a battery module housing. The battery module cells 74, CMU 76, housing, coolant lines, busbars, etc., collectively define the cell module assembly.

With continuing reference to FIG. 1, the motor vehicle 10 provisions flexible monitoring, notification, and management services for permanent and portable electronic devices (“assets”) that are within one of the available compartments of the vehicle 10. As used herein, the term “asset” may be broadly defined to include any personal property or tangible object that comes manufacturer equipped with or to which may be affixed an SRC device. Likewise, the term “compartment” may be broadly defined to include any section of a vehicle, enclosed or otherwise, such as the passenger cabin, engine bay, trunk, truck bed, wheel well, etc. By way of non-limiting example, FIG. 1 illustrates a single user 11 communicating with a single motor vehicle 10 using a single asset, namely a handheld smartphone 13. With that said, it is envisioned that any number of users may communicate with any number of vehicles with a variety of distinct asset types that are suitably equipped for short-range exchanges of information and data. In this regard, the user's smartphone 13 may communicate directly with the telematics unit 14 of motor vehicle 10 using a short-range communication (SRC) device, examples of which include a BLUETOOTH® or near field communication (NFC) or infrared (IR) transceiver, a radio frequency identification (RFID) tag, a dedicated short-range communications (DSRC) component, a wireless fidelity (WiFi) module, a ZIGBEE® device, etc.

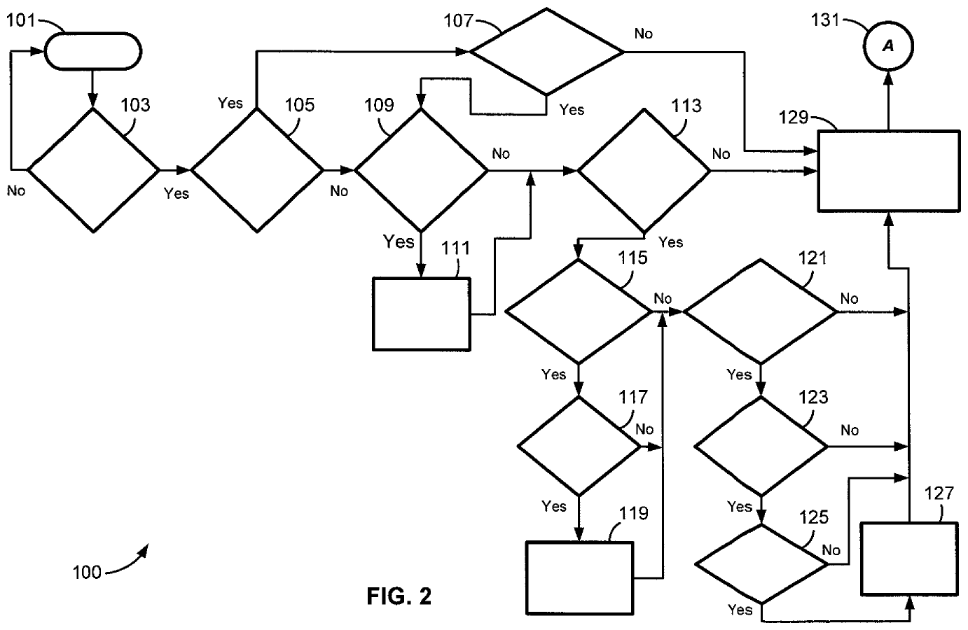

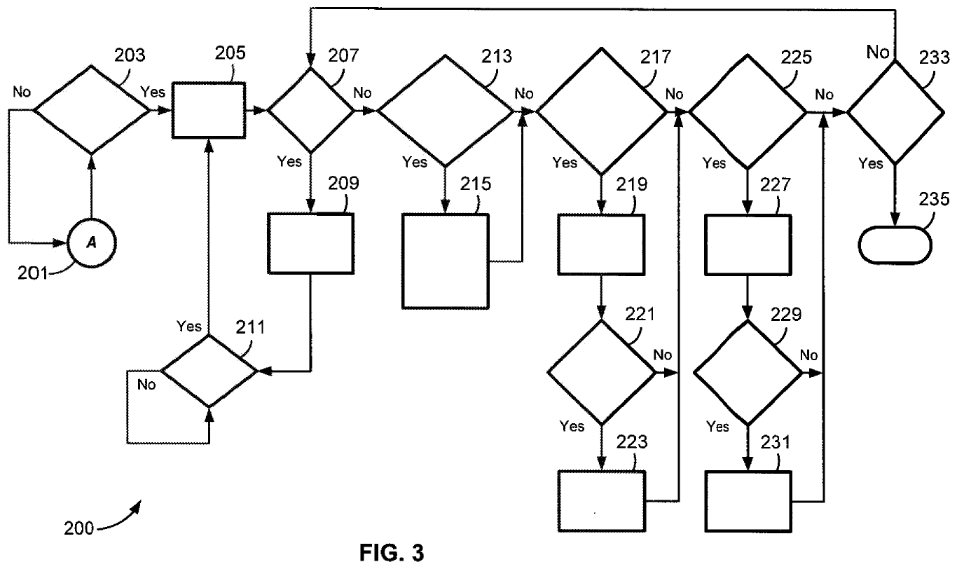

With reference next to the flow chart of FIG. 2, an improved method or control strategy for detecting and inventorying an electronic asset, such as smartphone 13 of FIG. 1, that is located inside a compartment of a host vehicle, such as the passenger compartment of automobile 10, is generally described at 100 in accordance with aspects of the present disclosure. Shown and generally described at 200 in FIG. 3 is an improved method or control strategy for automating vehicle responses and warnings for protection of in-vehicle assets. Some or all of the operations illustrated in FIGS. 2 and 3, and described in further detail below, may be representative of an algorithm that corresponds to processor-executable instructions that are stored, for example, in main or auxiliary or remote memory (e.g., memory device 38 of FIG. 1), and executed, for example, by an electronic controller, processing unit, logic circuit, or other module or device or network of modules/devices (e.g., CPU 36 and/or cloud computing service 24 of FIG. 1), to perform any or all of the above and below described functions associated with the disclosed concepts. It should be recognized that the order of execution of the illustrated operation blocks may be changed, additional operation blocks may be added, and some of the described operations may be modified, combined, or eliminated.

Methods 100 and 200 begin at START terminal block 101 of FIG. 2 with memory-stored, processor-executable instructions for a programmable controller or control module or similarly suitable processor to call up an initialization procedure for a flexible asset notification and management protocol. This routine may be executed in real-time, near real-time, continuously, systematically, sporadically, and/or at regular intervals, for example, each 10 or 100 milliseconds during normal and ongoing operation of the motor vehicle 10. As yet another option, terminal block 101 may initialize responsive to a user command prompt, a resident vehicle controller prompt, or a broadcast prompt signal received from an “off-board” centralized vehicle services system (e.g., host cloud computing service 24). Upon completion of the control operations presented in FIGS. 2 and 3, the methods 100 and 200 may advance to END terminal block 235 of FIG. 3 and temporarily terminate or, optionally, may loop back to terminal block 101 and run in a continuous loop.

After protocol initialization, method 100 of FIG. 2 advances to DETECTION decision block 103 to determine if an asset has been detected within a compartment of a host vehicle. In accord with the illustrated example, a short-range communications device within the smartphone 13 may ping or be pinged by a resident communication interface device within the telematics unit 14. For a BLUETOOTH® application, the RCI may transmit an inquiry request and run an inquiry to try to discover the asset; the asset responds with device-specific information, such as a MAC address, unique device identifier (UDID) code, device name, etc. The RCI may then page the asset to form a connection (i.e., pair) between the two devices. After the two devices complete the paging process, they may enter a connection state and actively participate in wireless data exchanges. If an asset is not detected (block 103=NO), the method 100 may circle back to terminal block 101 and run in a continuous loop until an asset is detected or, alternatively, me temporarily terminate at terminal block 235.

Upon detection of an SRC device of an asset (block 103=YES), method 100 advances to RECOGNITION decision block 105 to determine if the asset is recognized by the host vehicle. For instance, a previously paired asset may have “bonded” with the host vehicle such that the two devices have already shared with each other their addresses, names, and profiles; this data is stored in memory for future retrieval and use. Any such bonded devices may automatically establish a connection whenever they are within sufficient proximity for short-range data exchanges.

If the vehicle recognizes the detected asset, e.g., as a prior-paired and bonded device (block 105=YES), the host vehicle may retrieve the asset's memory-stored profile. At the same time, the method 100 may execute SETTINGS CHANGE decision block 107 to determine whether the previously stored device-specific information should be maintained or replaced, in whole or in part. To effect this feature, the telematics unit 14 may display a prompt to a vehicle occupant with a request to select whether or not—YES or NO—they would like to replace any of the available device information contained in the asset's profile. If not (block 107=NO), method 100 may optionally execute RECORDED ASSET data output block 129 and display or otherwise notify the user of their selection(s) and related asset data.

When the vehicle does not recognize the detected asset (block 105=NO) or the user wishes to change a stored device setting of a recognized asset (block 107=YES), method 100 executes NAME decision block 109 to determine if a new name should be added for the asset. For instance, telematics unit 14 may display a prompt to a vehicle occupant with a request to select whether or not—YES or NO—they would like to enter a device name for the detected asset. If so (block 109=YES), the user enters a desired device name via an available HMI input device and the vehicle stores the new device name in its respective profile for the paired device at NAME STORAGE data block 111.

If a new device name is saved (block 111) or one is not desired (block 109=NO) for the detected asset, method 100 advances to CONDITIONAL SETTINGS decision block 113 to determine if a new conditional criterion should be added or an existing conditional criterion should be changed for the asset. In accord with disclosed concepts, the memory-stored asset profile contains device-related data and device-specific data for the detected asset. That is, in addition to standard device-related information (e.g., make, model, series, type, operating system, etc.), there is information within the asset profile that is unique to the detected asset being monitored. As noted above, device-specific data may include an assigned device name, MAC address, UDID code, serial number, etc. This device-specific data also contains a set of conditional criteria that is designed to protect the asset while inside the vehicle, as will be explained in extensive detail hereinbelow. Upon determining that no new conditional criteria will added and/or no existing conditional criteria will be changed (block 113=NO), method 100 executes data output block 129.

When a user wishes to add a new conditional criterion or modify an existing conditional criterion (block 113=YES), the user is prompted to enter the new/updated criteria setting(s). FIG. 2 presents a few non-limiting examples of conditional criteria for a detected asset that may be selectively modified by a user. At MAX/MIN TEMP decision block 115, for example, the method 100 determines if the user would like to add/modify/select a temperature criterion for the detected in-vehicle asset. If not (block 115=NO), method 100 advances to decision block 121 or another comparable process node for modifying one of the asset's conditional criteria. If so (block 115=YES), the user may choose a maximum temperature threshold setting and/or a minimum temperature threshold setting for a detected asset (e.g., an operating temperature range within which smartphone 13 will operate without being damaged). While illustrated and described as conditional operations, decision blocks 115, 117, 121, 123 and 125 of FIG. 2 may take on alternative forms, such as data input/output operations that do not carry out nor depend upon an “if-then” conditional construct.

After a user changes the temperature criteria for the detected in-vehicle asset (block 115=YES), or as part of an independent inquiry, the user may be prompted to add/modify/select a temperature notification setting at TEMP NOTIFICATION decision block 117. If not (block 117=NO), method 100 may transition from decision block 117 to decision block 121. User-selectable notification criteria may include a variety of different settings, such as a notification type (e.g., text, call, push, telematics prompt, haptic prompt, audible prompt, etc.) or a transmission time for the notification (e.g., immediate notification, X-minute delay, snooze period, etc.). If the user decides to add a max/min temp criterion or a notification timing criterion (block 115=YES &/OR block 117=YES), method 100 executes a TEMP SETTINGS data storage block 119 and stores the user-selected in the paired device's profile. It should be appreciated that greater, fewer, or alternative conditional criteria settings may be added by a driver, an occupant, or any other authorized party. Some examples of discretionary operational criteria may include a designation of an asset as perishable (e.g., groceries), a designation of an asset as valuable (e.g., wallet or laptop), a device charge status setting (e.g., minimum charge to trigger notification), a designation to not leave during day/night (e.g., a child or pet), etc.

Prior to, contemporaneous with, or after changing an asset's temperature settings at blocks 115, 117 and 119, method 100 may execute UNATTENDED VEHICLE decision block 121 to ascertain whether or not the user would like to add/modify/select vehicle dynamics criteria and/or a key-on/key-off criteria for the detected in-vehicle asset. If not (block 121=NO), method 100 may proceed directly to block 129. On the contrary, the user may choose to modify a vehicle dynamics/key-on/key-off criteria (block 121=YES); at that time, the user may select or modify threshold criteria that will trigger a warning that the vehicle is unattended and the asset may be at risk of theft or damage. For instance, the user may choose to trigger an automated vehicle notification/response upon determining that the vehicle is stopped and keyed off while the asset is in the passenger cabin. As yet a further option, the user may choose to trigger an automated vehicle notification/response upon determining that the vehicle is stopped and keyed-on while the asset is unexpectedly no longer in the passenger cabin.

After a user changes the unattended vehicle criteria for the detected in-vehicle asset (block 121=YES), or as part of an independent inquiry, the user may be prompted to add/modify/select a lock system setting at LOCK NOTIFICATION decision block 123 or an unattended notification setting at UNATTENDED NOTIFICATION decision block 125. If the user chooses to not change either settings (block 123=NO &/OR block 125=NO), method 100 may transition to data block 127 or data output block 129. These notification settings may take on any of the various options for notification settings described herein, such as choosing to send an immediate notification, send a notification after an X-minute delay, set a snooze period after which a supplemental reminder will be sent. At LOCK NOTIFICATION decision block 123, the user may select to send a notification if the vehicle doors are locked (or unlocked) while the asset is in (or illicitly removed from) the host vehicle. Upon completion of some or all of the operations illustrated in FIG. 2, method 100 transitions to first reference connector (A) 131.

With reference next to FIG. 3, method 200 begins at a second reference connector (A) 201, which indicates an algorithm transition or “jump” from method 100 on page 2/3 of the drawings to method 200 on page 3/3 of the drawings. From there, method 200 performs memory-stored instructions associated with CONDITIONAL CRITERIA decision block 203 to determine whether or not any of the conditional criteria assigned to the detected in-vehicle asset have been met. In accord with one representative example, the telematics unit 14 may concurrently determine that a conditional criteria is met when: (1) a subject asset is presently located within the passenger compartment; (2) the vehicle is stopped; (3) the vehicle is unattended; and (4) the real-time, measured cabin temperature for the passenger compartment exceeds a maximum operating temperature within the memory-stored device profile for the asset. Any of the other predefined conditional criteria described herein, singly, collectively or in any combination, may trigger an automated vehicle response/notification. If at least one of the conditional criteria has not been met (block 203=NO), method 200 may circle back to reference connector (A) 201 and run in a continuous loop until one or more conditional criteria have been met.

Upon determining that a conditional criterion has been met (block 203=YES), an automated electronic notification may be transmitted to a user at NOTIFICATION data output block 205 as part of, or in lieu of, an autonomous vehicle response. The notification may take on a variety of forms, including an audible notice (e.g., via speakers 30), a visual notice (e.g., via display 18), a push, text, call, or email (e.g., sent to a user's personal computing device), or any other suitable form of reporting. After sending the user a notification, method 200 determines if the user has chosen to delay an automated vehicle response at SNOOZE decision bock 207. If a user-selected request to delay vehicle response has been received (block 207=YES), method 200 retrieves a memory-stored time delay at SNOOZE TIME data input block 209. This time delay may be a user-defined or a system-default number of minutes between user-selected snoozing and a follow-up reminder. At SNOOZE LAPSE decision block 211, method 200 determines if the predefined snooze time has expired. If the snooze time has not yet expired (block 211=NO), method 200 may run in a continuous loop until the snooze timer expires. Upon expiration of the snooze time (block 211=YES), method 200 may transmit another notification to the user or, alternatively, may proceed to block 207 or directly to block 209.

If the user chooses to not snooze the notification (block 207=NO) or after expiration of the snooze timer (block 211=YES), one or more controller-governed responses may be automatically carried out in direct response to an in-vehicle asset criterion being met. By way of example, and not limitation, REMOTE SERVICES decision block 213 determines if an exigent situation exists that may warrant involvement by a remotely located third-party vehicle service (e.g., cloud computing host service 24 of FIG. 1). For instance, a set of conditional criteria may trigger third-party intervention when: (1) the asset is designated as “valuable”; (2) the vehicle is stopped; (3) the vehicle is unattended; and (4) the asset is no longer detected (e.g., likely stolen). If a situation does exist—as defined by the asset's predefined conditional criteria—that warrants urgent assistance (block 213=YES), method 200 carries out processor-executable instructions associated with REMOTE SERVICES data output block 215 to engage the third-party vehicle service to help resolve the issue. While illustrated and described as codependent operations, the determinations associated with decision blocks 213, 217 and 225 of FIG. 3 may be carried out independent of one another and, as a further option, may be carried out in any desired order of execution.

Upon determining that an exigent situation does not exist (block 213=NO), method 200 will assess at UNLOCKED ASSET decision block 217 if the met conditional criteria (block 203) indicate that the detected asset, which is designated as an asset that should not be left in an unlocked vehicle, has in fact been left in an unlocked vehicle. If not (block 217=NO), method 200 advances to decision block 225. Responsive to a determination that the asset has been left in an unlocked vehicle (block 217=YES), e.g., while the vehicle is stationary and unattended, method 200 may optionally transmit a notification to the user with an offer to lock the vehicle, as indicated at LOCK NOTIFICATION data output block 219. LOCK APPROVAL decision block 221 thereafter determines if the user has accepted locking of the vehicle. If approval to lock is not received from the user (block 221=NO), method 200 advances to decision block 225 without locking the vehicle. On the contrary, when the user inputs approval to lock the compartment that contains the asset or, if desired, to lock the entire vehicle (block 221=YES), a designated vehicle controller commands the vehicle's power lock system to lock the compartment/vehicle, as indicated at VEHICLE LOCK data output block 223.

After locking the vehicle at block 223, or as part of an independent inquiry, method 200 executes TEMP SENSITIVE decision block 225 to determine whether or not the met conditional criteria (block 203) indicate that the detected asset is a temperature-sensitive device that has been left in a potentially detrimental environment. If not (block 225=NO), method 200 may proceed to TERMINATION decision block 233 to determine if the notification has ended or, alternatively, may proceed directly to END terminal block 235. If the notification has not ended (block 233=NO), method 200 may loop back to block 207; if it has (block 233=YES), method 200 may advance to terminal block 235 and end.

Returning to the discussion of TEMP SENSITIVE decision block 225, the memory-stored predefined conditional criteria for a subject asset may fix a desired operating temperature range, e.g., of between about 0° C. and about 35° C. (˜32-95° F.); however, the detected asset may be stowed inside a trunk compartment with a measured temperature of 42° C. Upon determining that a detected asset is temperature-sensitive and is located within a vehicle compartment with a measured (real-time) temperature that is outside the asset's desired temperature range (block 225=YES), method 200 may optionally transmit a notification to the user with an offer to heat/cool the vehicle, as indicated at HVAC NOTIFICATION data output block 227. HVAC APPROVAL decision block 229 thereafter determines if the user has accepted heating/cooling of the vehicle. If HVAC approval is not received from the user (block 229=NO), method 200 advances to decision block 233 without heating/cooling the vehicle. On the contrary, when the user inputs approval for active thermal management of the vehicle compartment that contains the asset or, if desired, the entire vehicle (block 229=YES), a designated vehicle controller commands the vehicle's HVAC system to selectively modify the compartment/vehicle temperature, as indicated at HVAC ACTIVATION data output block 231.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of operating a motor vehicle having a vehicle controller, a vehicle compartment, and a resident communications interface (RCI) device operable to communicate with an electronic asset, the method comprising:
detecting, via a vehicle controller through the RCI device, the electronic asset within the vehicle compartment of the motor vehicle;
retrieving, via the vehicle controller from a memory device responsive to detecting the electronic asset, device data specific to the electronic asset, the device data including a set of conditional criteria predetermined to protect the asset while in the vehicle compartment;
detecting, via the vehicle controller, the motor vehicle is stopped;
determining, via the vehicle controller responsive to detecting the motor vehicle is stopped, if a conditional criterion in the set of conditional criteria has been met; and
transmitting, via the vehicle controller to a resident vehicle subsystem of the motor vehicle, a command signal to execute an automated control operation responsive to determining the conditional criterion has been met.

2. The method of claim 1, wherein the electronic asset includes a short-range communications (SRC) device, and wherein detecting the electronic asset within the vehicle compartment includes the RCI device wirelessly pairing with the SRC device.

3. The method of claim 1, wherein retrieving the device data includes:
determining the device data does not previously exist in the memory device;
prompting a user of the motor vehicle to enter the device data; and
storing, in the memory device, the device data associated with a unique identifier of the electronic asset.

4. The method of claim 1, wherein the set of conditional criteria included in the device data includes a notification criterion with a notification type setting and/or a notification transmission time setting.

5. The method of claim 1, wherein the set of conditional criteria included in the device data includes a temperature criterion with a temperature threshold setting and/or a temperature notification setting.

6. The method of claim 1, wherein the set of conditional criteria included in the device data includes a lock system criterion with a lock status setting and/or a lock notification setting.

7. The method of claim 1, wherein the vehicle compartment includes a passenger compartment, the resident vehicle subsystem includes an electronic display device mounted inside the passenger compartment, and the command signal causes the electronic display device to display a notification indicating the conditional criterion has been met.

8. The method of claim 7, further comprising:
receiving, after displaying the notification, a snooze input from a user to snooze the notification;
determining, responsive to receiving the snooze input, if a memory-stored notification timer has expired; and
displaying, via the electronic display device responsive to the notification timer having expired, a second notification indicating the conditional criterion has been met.

9. The method of claim 1, wherein the vehicle compartment includes a passenger compartment, the resident vehicle subsystem includes a power lock system operable to lock the passenger compartment, and the command signal causes the power lock system to enter a lock mode and thereby lock the passenger compartment responsive to the conditional criterion being met.

10. The method of claim 9, further comprising:
transmitting, via the vehicle controller to a user of the motor vehicle, a prompt to approve locking of the motor vehicle; and
receiving, from the user, a lock mode approval to lock the motor vehicle;
wherein the command signal is sent to power lock system to enter the lock mode further in response to receiving the lock mode approval.

11. The method of claim 1, wherein the vehicle compartment includes a passenger compartment, the resident vehicle subsystem includes a telematics unit mounted inside the passenger compartment, and the command signal causes the telematics unit to transmit an intervention service request to a third-party vehicle service remote from the motor vehicle.

12. The method of claim 11, further comprising, after detecting the electronic asset within the vehicle compartment of the motor vehicle:
detecting, via the vehicle controller through the RCI device, removal of the electronic asset from the vehicle compartment; and
determining a power lock system of the motor vehicle is in a lock mode,
wherein the command signal is sent to the telematics unit to transmit the intervention service request further in response to detecting removal of the electronic asset from the vehicle compartment concurrent with the power lock system being in the lock mode.

13. The method of claim 1, wherein the vehicle compartment includes a passenger compartment, the resident vehicle subsystem includes a heating, ventilation and air-conditioning (HVAC) system operable to regulate a cabin temperature of the passenger compartment, and the command signal activates the HVAC system to heat or cool the passenger compartment to a predefined cabin temperature retrieved from the set of conditional criteria specific to the asset.

14. The method of claim 13, further comprising:
transmitting, via the vehicle controller to a user of the motor vehicle, a prompt to approve activation of the HVAC system; and
receiving, from the user, an HVAC activation approval,
wherein the command signal is sent to HVAC system to heat or cool the passenger compartment in response to receiving the HVAC activation approval.

15. A non-transitory, computer-readable medium storing instructions executable by one or more processors of a vehicle controller of a motor vehicle, the motor vehicle including a vehicle compartment and a resident communications interface (RCI) device operable to communicate with an electronic asset, the instructions, when executed by the one or more processors, causing the vehicle controller to perform operations comprising:
detecting the electronic asset within the vehicle compartment using the RCI device;
retrieving, from a memory device responsive to detecting the electronic asset, device data specific to the electronic asset, the device data including a set of conditional criteria predetermined to protect the asset while in the vehicle compartment;
detecting the motor vehicle is stopped;
determining, responsive to detecting the motor vehicle is stopped, if a conditional criterion in the set of conditional criteria has been met; and
transmitting, to a resident vehicle subsystem of the motor vehicle, a command signal to execute an automated control operation responsive to determining the conditional criterion has been met.

16. A motor vehicle, comprising:
a vehicle body with a vehicle compartment;
a plurality of road wheels attached to the vehicle body;
a prime mover attached to the vehicle body and operable to drive one or more of the road wheels to thereby propel the motor vehicle;
a resident communications interface (RCI) device attached to the vehicle body and operable to communicate with an electronic asset; and
a vehicle controller programmed to:
detect the electronic asset within the vehicle compartment using the RCI device;
retrieve, from a memory device responsive to detecting the electronic asset, device data specific to the electronic asset, the device data including a set of conditional criteria predetermined to protect the asset while in the vehicle compartment;
detect the motor vehicle is stopped;
determine, responsive to detecting the motor vehicle is stopped, if a conditional criterion in the set of conditional criteria has been met; and
transmit a command signal to a resident vehicle subsystem of the motor vehicle to execute an automated control operation responsive to determining the conditional criterion has been met.

17. The motor vehicle of claim 16, wherein the electronic asset includes a short-range communications (SRC) device, and wherein detecting the electronic asset within the vehicle compartment includes the RCI device wirelessly pairing with the SRC device.

18. The motor vehicle of claim 16, wherein the set of conditional criteria included in the device data includes:
a notification criterion with a notification type setting and/or a notification transmission time setting;
a temperature criterion with a temperature threshold setting and/or a temperature notification setting; and/or
a lock system criterion with a lock status setting and/or a lock notification setting.

19. The motor vehicle of claim 16, wherein the vehicle compartment includes a passenger compartment, the resident vehicle subsystem includes an electronic display device mounted inside the passenger compartment, and the command signal causes the electronic display device to display a notification indicating the conditional criterion has been met.

20. The motor vehicle of claim 16, wherein the vehicle compartment includes a passenger compartment, the resident vehicle subsystem includes a heating, ventilation and air-conditioning (HVAC) system operable to regulate a cabin temperature of the passenger compartment, and the command signal activates the HVAC system to heat or cool the passenger compartment to a predefined cabin temperature retrieved from the set of conditional criteria specific to the asset.
